(19) United States
(12) Patent Application Publication
(10) Pub. No.: US 2022/0341143 A1
(43) Pub. Date: Oct. 27, 2022

(54) WATER-FLOW SENSING DEVICES AND METHODS OF SENSING AND STOPPING AN EXCESSIVE FLOW CONDITION

(71) Applicant: Full Basement Self Storage, LLC, Liburn, GA (US)

(72) Inventor: Daryl R. Dunahoo, Pendergrass, GA (US)

(73) Assignee: Full Basement Self Storage, LLC, Liburn, GA (US)

(21) Appl. No.: 17/728,515

(22) Filed: Apr. 25, 2022

Related U.S. Application Data
(60) Provisional application No. 63/179,588, filed on Apr. 26, 2021.

(51) Int. Cl. E03D 5/10; E03D 1/26; G05D 9/12

(52) U.S. Cl. CPC E03D 5/10; E03D 1/266; G05D 9/12

(57) ABSTRACT

Devices and methods are provided for sensing and stopping an excessive water-flow condition in a water-using appliance such as a toilet. Such excessive water-flow conditions can occur, for example, when a leak or other malfunction is present in the appliance. The devices measure and monitor the time that elapses after the commencement of water flow to the appliance, and interrupt the water supply when the elapsed time reaches a predetermined value. Alternatively, the devices measure and monitor the cumulative volume of water that flows to the appliance after the commencement of water flow, and interrupt the water supply when the cumulative volume reaches a predetermined value.

### CROSS-REFERENCE TO RELATED APPLICATIONS

This application claims the benefit under 35 U.S.C. § 119(e) to U.S. Provisional Patent Application No. 63/179,588 filed Apr. 26, 2021, the contents of which are incorporated by reference herein in their entirety.

### FIELD

The disclosed technology relates generally to water-using appliances, such as toilets, and more particularly, to devices and methods for sensing and stopping an excessive water-flow condition in such appliances.

### BACKGROUND

In a typical flush toilet, a fill valve senses the water level in the toilet tank, and permits water to enter the tank until the water level reaches a “stop” setpoint. Current toilet designs have no secondary or backup mechanism to stop the water flow into the tank when a malfunction or other factor causes water to enter the tank after the water level has reached the stop setpoint.

One common type of toilet malfunction occurs when the flapper within the tank is stuck open or otherwise does not seat properly, which allows water to leak continuously from the tank. Another common toilet malfunction occurs when the “full” setpoint is set too high, which can result in a continuous flow of water into the overflow tube of the tank. Under these circumstances, the toilet fill valve continues to add water in an attempt to fill the tank while the water continues to leak out. Another example of a common toilet malfunction is a leaky flapper, which typically causes a slow leak. In response, the toilet fill valve adds water intermittently to maintain the water level in the tank at the full setpoint.

Over time, a leaky toilet can waste in hundreds, or even thousands of gallons of water. And this problem can be acute in dwellings, such as rental units, seasonal dwellings, etc., that may remain unoccupied for long periods of time.

### SUMMARY

In one aspect of the disclosed technology, a water flow sensing device and method of sensing and stopping an excessive flow condition are provided.

In another aspect of the disclosed technology, a toilet system includes a meter device and/or a meter/valve device for sensing the amount of water flowing into the toilet tank, and stopping the flow if and when an amount of water is detected that exceeds by some amount the expected toilet tank fill volume.

In another aspect of the disclosed technology, a toilet system includes a meter device and/or a meter/valve device capable of generating a fault condition if and when an amount of water is detected that exceeds by some amount the expected toilet tank fill volume.

In another aspect of the disclosed technology, a toilet system includes a meter device, where the meter device is a flow volume-based meter device that operates based on a predetermined volume setpoint.

In another aspect to the disclosed technology, a toilet system includes a meter device, where the meter device is a flowtime-based meter device that operates based on a predetermined time setpoint.

In another aspect of the disclosed technology, a toilet system includes a meter device, where the meter device is located inside the toilet tank and in direct communication with the toilet fill valve for stopping the flow.

In another aspect of the disclosed technology, a toilet system includes a meter/valve device that includes both a flow volume-based meter device and a built-in flow valve that operates based on a predetermined volume setpoint.

In another aspect of the disclosed technology, a toilet system includes a meter/valve device that can include both a flowtime-based meter device and a built-in flow valve that operates based on a predetermined time setpoint.

In another aspect of the disclosed technology, a toilet system includes a meter device, where the meter device may be a flow volume-based meter device, a flowtime-based meter device, a flow volume-based meter/valve device, or a flowtime-based meter/valve device that operate based on an automatic or manual reset function.

In another aspect of the disclosed technology, a toilet system includes a flowtime-based meter/valve device and/or a flow volume-based meter/valve device located inside the toilet tank.

In another aspect of the disclosed technology, a toilet system includes a flowtime-based meter/valve device and/or a flow volume-based meter/valve device located outside the toilet tank.

In another aspect of the disclosed technology, a toilet system includes a flowtime-based meter/valve device and/or a flow volume-based meter/valve device located outside the toilet tank, and a communication mechanism is provided from inside the toilet tank, and runs outside the toilet tank to the meter/valve device.

In another aspect of the disclosed technology, a toilet fill valve assembly include a flow volume-based meter device, a flowtime-based meter device, a flow volume-based meter/valve device, or a flowtime-based meter/valve device.

In another aspect of the disclosed technology, a water system includes a meter/valve fluidly coupled to any type of water-using appliance.

In another aspect of the disclosed technology, a smart water system includes a smart meter/valve fluidly coupled to any type of smart water-using appliance, and the smart water system may include wireless communications.

In another aspect of the disclosed technology, a method is provided for operating a water flow sensing mechanism, such as a toilet system including a meter device, where the meter device is a flow volume-based meter device, a flowtime-based meter device, a flow volume-based meter/valve device, or a flowtime-based meter/valve device.

In another aspect of the disclosed technology, a meter device is configured for use with a toilet system and a water supply. The toilet system includes a toilet tank; a flush valve; a toilet bowl fluidly coupled to the toilet tank upon actuation of the flush valve; and a fill valve configured to be fluidly coupled to the water supply via the meter device, and to supply water to the toilet tank to maintain a water level in the tank at a fill level.

The meter device includes a fault device configured to be mechanically coupled to the fill valve of the toilet, where the fault device is further configured to, during operation, interrupt a flow of water through the fill valve when the fault device is actuated. The meter device also includes one of: a flow meter mechanically coupled to the fault device and configured to be fluidly coupled to the water supply and the fill valve, where the flow meter is further configured to, during operation, (i) determine a cumulative volume of water that flows from the water supply to the fill valve after the flow meter has been reset, and (ii) actuate the fault device when the cumulative volume of water exceeds a setpoint for the cumulative volume of water; and a timer mechanically coupled to the fault device and configured to be fluidly coupled to the water supply and the fill valve, where the timer is further configured to, during operation, (i) determine an elapsed time after the timer has been reset and during which water flows from the water supply to the fill valve, and (ii) actuate the fault mechanism when the elapsed time exceeds a setpoint for the elapsed time.

In another aspect of the disclosed technology, a meter device configured for use with a water-using appliance includes a flow valve configured to be fluidly coupled to the appliance and configured to, during operation, interrupt a flow of water to the appliance when the flow valve is actuated. The meter device also includes one of: a flow meter mechanically or electrically coupled to the flow valve and configured to be fluidly coupled to the flow valve and a water supply, where the flow meter is configured to, during operation, (i) determine a cumulative volume of water that flows from the water supply to the appliance after the flow meter has been reset, and (ii) actuate the flow valve when the cumulative volume of water exceeds a setpoint for the cumulative volume of water; and a timer mechanically or electrically coupled to the flow valve and configured to be fluidly coupled to the flow valve and the water supply, where the timer is configured to, during operation, (i) determine an elapsed time after the timer has been reset and during which water flows from the water supply to the appliance, and (ii) actuate the flow valve when the elapsed time exceeds a setpoint for the elapsed time.

In another aspect of the disclosed technology, a meter device is configured for use with a toilet system and a water supply. The toilet system includes a toilet tank; a flush valve; a toilet bowl fluidly coupled to the toilet tank upon actuation of the flush valve; and a fill valve configured to be fluidly coupled to the water supply via the meter device, and to supply water to the toilet tank to maintain a water level in the tank at a fill level.

The meter device includes a fault valve configured to be fluidly coupled to the water supply and the fill valve of the toilet, and further configured to, during operation, interrupt a flow of water from the water supply to the fill valve on a selective basis; and a timer operably coupled to the fault valve and configured to, during operation, (i) determine an elapsed time after actuation of the flush valve; and (ii) cause the fault valve to prevent the flow of water from the water supply to the fill valve when the elapsed time reaches a setpoint.

In another aspect of the disclosed technology, the timer is a programmable digital timer communicatively coupled to the fault valve.

In another aspect of the disclosed technology, the fault valve is further configured to operate in an open state in which the fault valve permits the flow of water from the water supply to the fill valve, and a closed state in which the fault valve prevents the flow of water from the water supply to the fill valve.

In another aspect of the disclosed technology, the timer is further configured to energize the fault valve when the flush valve is actuated; and the fault valve is further configured to change from the closed state to the open state upon being energized.

In another aspect of the disclosed technology, the timer is further configured to de-energize the fault valve when the elapsed time after actuation of the flush valve reaches the setpoint; and the fault valve is further configured to change from the open state to the closed state upon being de-energized.

In another aspect of the disclosed technology, the timer is further configured to generate a first output when the flush valve is actuated; and the fault valve is further configured to change from the closed state to the open state upon receiving the first output.

In another aspect of the disclosed technology, the timer is further configured to generate a second output when the elapsed time reaches the setpoint; and the fault valve is further configured to change from the open state to the closed state upon receiving the second output.

In another aspect of the disclosed technology, the timer is further configured to reset the elapsed time to zero when the elapsed time reaches the setpoint.

In another aspect of the disclosed technology, the setpoint is an amount of time longer than an amount of time needed for the water level in the toilet tank to reach the fill level after actuation of the flush valve.

In another aspect of the disclosed technology, the device further includes a switch operably coupled to the timer and configured to generate an output when the flush valve is actuated.

In another aspect of the disclosed technology, the timer is further configured to: (i) begin determining the elapsed time after actuation of the flush valve upon receiving the output of the switch, and (ii) cause the fault valve to change from the closed state to the open state upon receiving the output of the switch.

In another aspect of the disclosed technology, the switch is a reed switch communicatively coupled to the timer.

In another aspect of the disclosed technology, the meter device further includes a magnet. The magnet is in a first position in relation to the reed switch as the flush valve is actuated; the magnet is in a second position in relation to the reed switch when the flush valve is not actuated; the reed switch is configured to close when the magnet is in the first position in relation to the reed switch; and the reed switch is configured to generate the output of the reed switch when the reed switch is closed.

In another aspect of the disclosed technology, a meter device is configured for use with a toilet system and a water supply. The toilet system includes a toilet tank; a flush valve; a toilet bowl fluidly coupled to the toilet tank upon actuation of the flush valve; and a fill valve configured to be fluidly coupled to the water supply via the meter valve, and to supply water to the toilet tank to maintain a water level in the tank at a fill level

The meter device includes a flow valve configured to be fluidly coupled to the fill valve of the toilet, where the flow valve is further configured to, during operation, interrupt a flow of water to the fill valve when the flow valve is actuated. The meter device also includes a flow meter mechanically or electrically coupled to the flow valve and configured to be fluidly coupled to the flow valve and the water supply. The flow meter is configured to, during operation, (i) determine a cumulative volume of water that flows from the water supply to the fill valve after the flow meter has been reset, and (ii) actuate the flow valve when the cumulative volume of water exceeds a setpoint for the cumulative volume of water.

In another aspect of the disclosed technology, the fault device is a linkage.

In another aspect of the disclosed technology, the flow meter includes an impeller configured to rotate in response to passage of the water over the impeller. The linkage includes a gear mounted on the impeller for rotation with the impeller, and a geared rod mechanically coupled to the fill valve, the geared rod being configured to engage the gear so that the geared rod translates linearly toward the fill valve in response to rotation of the gear.

In another aspect of the disclosed technology, the device further includes a reset mechanism configured to reset the flow meter.

In another aspect of the disclosed technology, the reset mechanism includes a reset linkage mechanically coupled to the flow meter. The reset linkage is configured to be mechanically coupled to the flush handle of the toilet so that the reset linkage is actuated by movement of the flush handle; and the flow meter is further configured so that actuation of the reset linkage resets the flow meter.

In another aspect of the disclosed technology, the volume setpoint is a volume of water greater than the fill volume of the toilet tank.

In another aspect of the disclosed technology, the fault device is configured to be coupled to a float of the fill valve of the toilet, and to interrupt a flow of water through the fill valve by raising the float.

### BRIEF DESCRIPTION OF THE DRAWINGS

Having thus described the presently disclosed subject matter in general terms, reference will now be made to the accompanying drawings, which are not necessarily drawn to scale, and wherein:

FIG. 1 illustrates a block diagram of a toilet system including a meter device, which is an example of the presently disclosed water flow sensing mechanism for sensing and stopping an excessive flow condition;

FIG. 2 illustrates a front view of a toilet tank and showing an example of the physical implementation of the toilet system shown in FIG. 1;

FIG. 3A and FIG. 3B illustrate block diagrams of two examples of the meter device shown in FIG. 1 and FIG. 2;

FIG. 4 illustrates front views of an example of a mechanical flow meter device and an example of a process of interrupting the flow in an excessive flow condition;

FIG. 5 illustrates a side view of an example of a toilet fill valve assembly including a meter device for sensing and stopping an excessive flow condition;

FIG. 6A and FIG. 6B illustrate schematic diagrams of the operation of a time-based and a volume-based meter device, respectively, in the absence of an excessive flow condition;

FIG. 7A and FIG. 7B illustrate schematic diagrams of the operation of a time-based and a volume-based meter device, respectively, in the presence of an excessive flow condition;

FIG. 8 illustrates a flow diagram of an example of a method of operation of the toilet system including the presently disclosed water flow sensing mechanism shown and described with reference to FIG. 1 through FIG. 7B;

FIG. 9 illustrates a block diagram of a toilet system including a meter device, which is another example of the presently disclosed water flow sensing mechanism for sensing and stopping an excessive flow condition;

FIG. 10 illustrates a front view of a toilet tank and showing an example of the physical implementation of the toilet system shown in FIG. 9;

FIG. 11 illustrates a block diagram of a toilet system including a meter/valve device, which is yet another example of the presently disclosed water flow sensing mechanism for sensing and stopping an excessive flow condition;

FIG. 12 illustrates a front view of a toilet tank and showing an example of the physical implementation of the toilet system shown in FIG. 11;

FIG. 13A and FIG. 13B illustrate block diagrams of two examples of the meter/valve devices shown in FIG. 11 and FIG. 12;

FIG. 14 illustrates a block diagram of a toilet system and showing an example of the meter/valve device located outside the tank, which is yet another example of the presently disclosed water flow sensing mechanism for sensing and stopping an excessive flow condition;

FIG. 15 illustrates a front view of a toilet tank and showing an example of the physical implementation of the toilet system shown in FIG. 14;

FIG. 16 illustrates a block diagram of a toilet system and showing another example of the meter/valve device located outside the tank, which is yet another example of the presently disclosed water flow sensing mechanism for sensing and stopping an excessive flow condition;

FIG. 17 illustrates a front view of a toilet tank and showing an example of the physical implementation of the toilet system shown in FIG. 16;

FIG. 18 illustrates a block diagram of a water system including the meter/valve, which is yet another example of the presently disclosed water flow sensing mechanism for sensing and stopping an excessive flow condition;

FIG. 19 illustrates a block diagram of a “smart” water system including a “smart” meter/valve, which is still another example of the presently disclosed water flow sensing mechanism for sensing and stopping an excessive flow condition; and

FIG. 20A and FIG. 20B illustrate block diagrams of two examples of “smart” meter/valve devices shown in FIG. 19.

FIG. 21 is a block diagram of a water system including a meter/valve, which is yet another example of the presently disclosed water flow sensing mechanism for sensing and stopping an excessive flow condition;

FIG. 22 is a front view of a toilet tank and showing an example of the physical implementation of the toilet system shown in FIG. 21.

### DETAILED DESCRIPTION

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

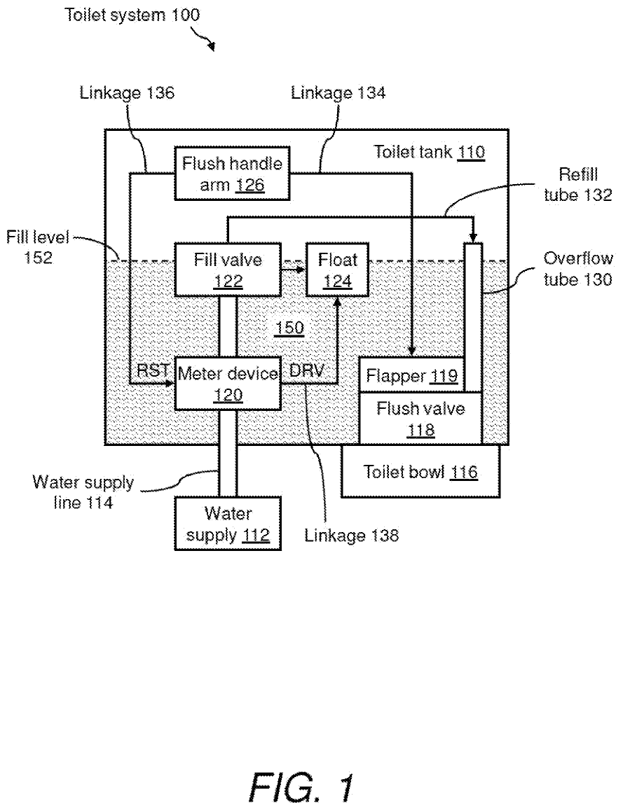

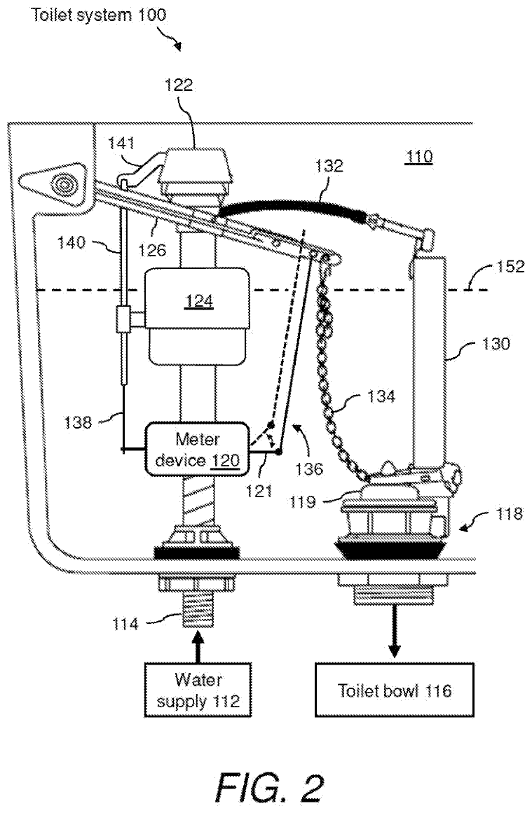

FIG. 1 is a block diagram of a toilet system 100 including a meter device, which is an example of the presently disclosed water flow sensing mechanism for sensing and stopping an excessive flow condition. FIG. 2 is a front view of a toilet tank 110, showing an example of the physical implementation of toilet system 100 shown in FIG. 1.

The toilet system 100 includes a toilet tank 110 that is fluidly coupled to a water supply 112 via a water supply line 114. The water supply 112 can be the standard building water supply. The toilet tank 110 is fluidly coupled to a toilet bowl 116 via a flush valve 118. The flush valve 118 includes a flapper 119. Installed inside toilet tank 110 may be, for example, a meter device 120, a fill valve 122, a float 124, a flush handle arm 126, an overflow tube 130, and a refill tube 132. A linkage 134, e.g., a chain as shown in FIG. 2 is positioned between the flush handle arm 126 and the flapper 119. As can be seen in FIG. 2, the fill valve 122 further includes a fill valve linkage 140 that couples a fill valve arm 141 to the float 124.

In the toilet system 100 shown in FIG. 2, the arrangement of the flush valve 118, including the flapper 119; the fill valve 122; the float 124; the flush handle arm 126; the overflow tube 130; the refill tube 132; the linkage 134; and the fill valve linkage 140 is well known. The toilet tank 110 holds a volume of water 150 that fills to a predetermined fill level 152 under the control of the fill valve 122.

The toilet system 100 differs from standard toilet systems in that it includes the meter device 120 that is designed to sense the amount of water flowing through the fill valve 122, and stop the flow if and when an amount of water is detected that exceeds by some amount the expected toilet tank fill volume. An excessive flow condition may occur, for example, when there is a malfunction in the flush operation of toilet system 100. For example, common malfunctions include a leaky flapper 119 allowing a slow leak down the flush valve 118; a stuck open flapper 119 allowing a continuous leak down the flush valve 118; or the “full” setpoint being set too high, allowing a continuous leak down the overflow tube 130.

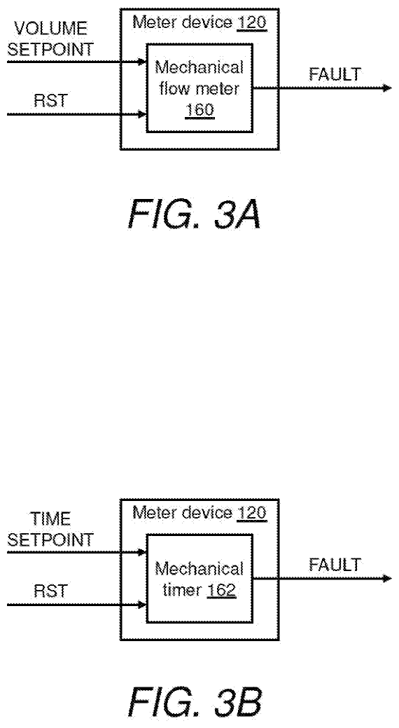

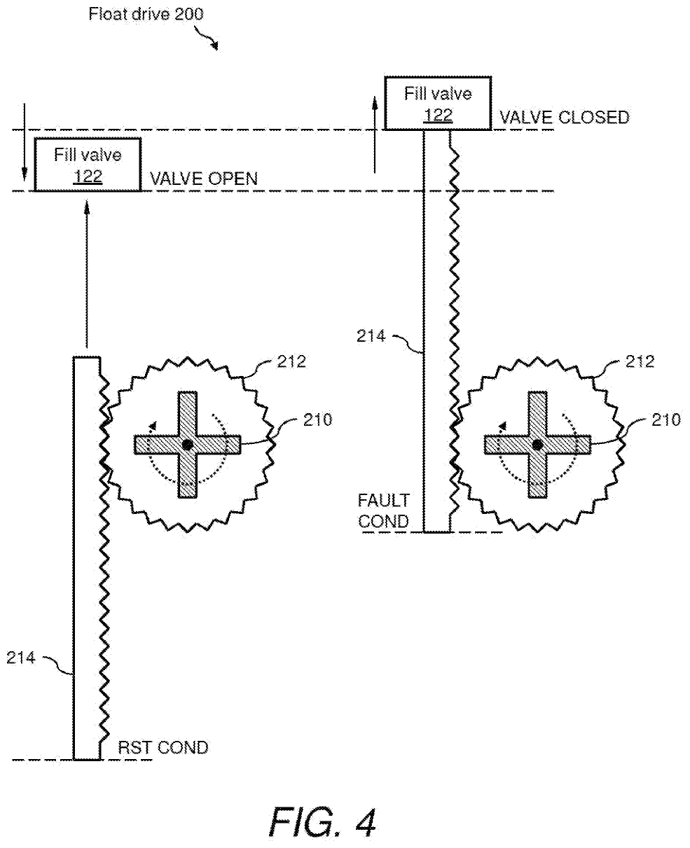

In the toilet system 100, the meter device 120 and the fill valve 122 may be arranged along, and in fluid communication with the water supply 112. The meter device 120 can be positioned between the water supply 112 and the fill valve 122. Referring to FIG. 3A and FIG. 3B, the meter device 120 may be based on a mechanical flow meter design (see FIG. 4) or, alternatively, a mechanical timer design.

For example, FIG. 3A shows an embodiment of the meter device 120 that includes a mechanical flow meter 160, e.g., a flow-based meter device 120. The mechanical flow meter 160 is used to measure the volume of water flowing through it, and to provide an indication of when the flow volume exceeds a certain desired value. The mechanical flow meter 160 operates mechanically, not electrically, and is configured to operate while submerged in water.

The mechanical flow meter 160 may operate based on a flow volume setpoint, e.g., VOLUME SETPOINT. For example, for a 1.6-gallon toilet tank 110, the VOLUME SETPOINT is some amount greater than 1.6 gallons. For example, the VOLUME SETPOINT may be two gallons, or five gallons. In another example, for a 3.5-gallon toilet tank 110, the VOLUME SETPOINT is some amount greater than 3.5 gallons. For example, the VOLUME SETPOINT may be five gallons in this example. The VOLUME SETPOINT may be fixed or adjustable.

When the measured flow reaches the VOLUME SETPOINT amount, the mechanical flow meter 160 provides a mechanism for interrupting, i.e., stopping, the flow. In one example, a fault (FAULT) mechanism may be provided between the mechanical flow meter 160 and the float 124, by which mechanical flow meter 160 physically moves the float 124 upward to close, i.e., turn off, the fill valve 122. The FAULT mechanism may be in the form of a physical linkage 138 between the meter device 120 and the float 124, as shown in FIG. 2.

Also, the operation of mechanical flow meter 160 includes a reset (RST) operation. For example, the flow-measurement operation of the mechanical flow meter 160 is reset at each flush operation. In one embodiment, the movement of flush handle arm 126 to initiate a flush may be used to reset the mechanical flow meter 160. In this embodiment, a linkage 136 may be provided between flush handle arm 126 and mechanical flow meter 160. More specifically, FIG. 2 shows an arm 121 of meter device 120 that may be toggled via the linkage 136 to the flush handle arm 126. Like the linkage 134, the linkage 136 may be a chain.

FIG. 3B shows an embodiment of the meter device 120 that includes a mechanical timer 162, e.g., FIG. 3B depicts a timer-based meter device 120. The mechanical timer 162 is used to measure the amount of time that water flows through it, and to provide an indication when the flowtime exceeds a certain desired value. The mechanical timer 162 operates mechanically, not electrically, and is configured to operate while submerged in water. The mechanical timer 162 may operate based on a flowtime setpoint, e.g., TIME SETPOINT. In one example, for a 1.6-gallon toilet tank 110, the TIME SETPOINT is some amount of time greater than the expected fill time of a 1.6-gallon toilet tank 110. For example, if the expected fill time of a 1.6-gallon toilet tank 110 is one minute, then the TIME SETPOINT may be two minutes. In another example, if the expected fill time of a 3.5-gallon toilet tank 110 is two minutes, then the TIME SETPOINT may be four minutes. The TIME SETPOINT may be fixed, or adjustable by the user.

When the measured flowtime reaches the TIME SETPOINT amount, the mechanical timer 162 provides a fault (FAULT) mechanism for interrupting, i.e., stopping, the flow, as depicted in FIG. 3A. Further, the operation of the mechanical timer 162 also includes the reset (RST) operation, as also depicted in FIG. 3A. In another example, in the flow-based meter device 120 and/or the timer-based meter device 120, the reset (RST) may be generated automatically via a timer. For example, if the expected tank fill time is one minute, then a reset may be generated automatically after two minutes, and if the flow-based meter device 120 and/or the timer-based meter device 120 are sensing no water flow. If water flow is sensed at the two-minute mark, then no automatic reset is generated.

FIG. 4 includes front views of an example of a mechanical flow meter device 200, and an example of a process of interrupting the flow in an excessive flow condition. The mechanical flow meter device 200 may be an example of a mechanism used in the mechanical flow meter 160 of the meter device 120 shown in FIG. 3A. The mechanical flow meter device 200 may include, for example, an impeller 210 coupled to a gear 212, where the impeller 210 and the gear 212 are rotatable due to the flow of water through the impeller 210. Also, the gear 212 can be coupled to a geared rod 214. Note that FIG. 4 depicts a simplified arrangement of the mechanical flow meter device 200 to illustrate the concept.

The rotating action of the impeller 210 and the gear 212 can be used to drive the geared rod 214 linearly. In the reset condition (RST COND), the position of geared rod 214 is well below, and out of contact with the float 124. As water flows through mechanical flow meter device 200, the geared rod 214 translates upward, and toward the fill valve 122. For example, the geared rod 214 may be engaged with the fill valve linkage 140 and/or the fill valve arm 141 of the fill valve 122. Under normal operating conditions, the geared rod 214 never reaches the point of closing the fill valve 122, and the geared rod 214 is reset to its lowest level with each flush. However, in the case of a toilet malfunction resulting in an excessive flow volume or flowtime, the geared rod 214 translates upward toward the fill valve 122, and eventually reaches a point where the geared rod 214 closes the fill valve 122.

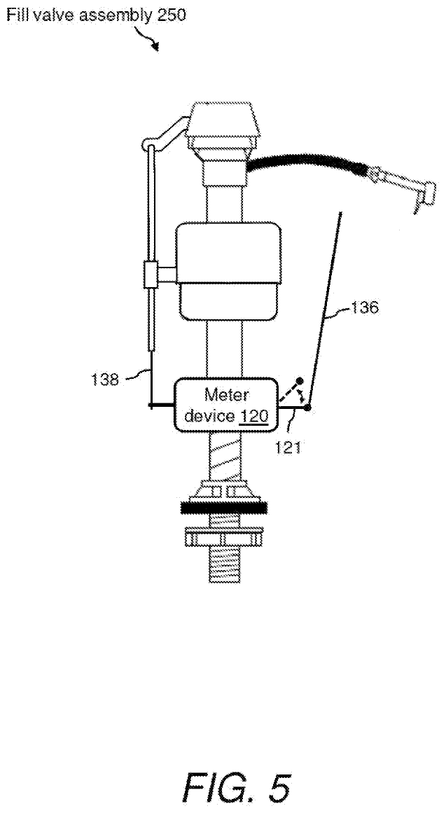

FIG. 5 is a side view of an embodiment of a toilet fill valve assembly 250 including the meter device 120 for sensing and stopping an excessive flow condition. Accordingly, the toilet fill valve assembly 250 and its linkages 136 and 138 may be provided to easily replace any standard commercially available toilet fill valve.

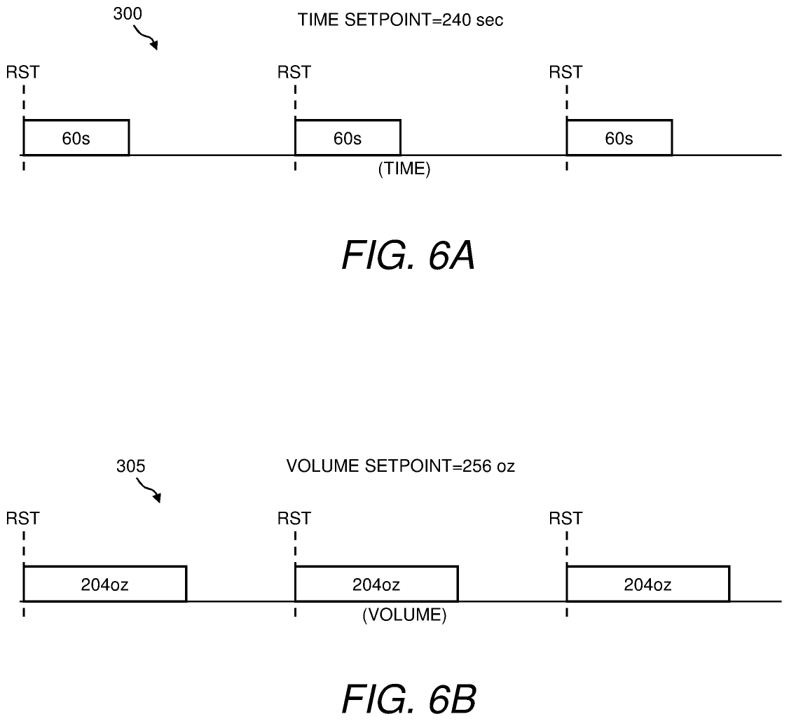

FIG. 6A and FIG. 6B are schematic diagrams of the operation of a time-based and a volume-based meter device 120, respectively, in the absence of an excessive flow condition, i.e., in the absence a FAULT condition. For example, the schematic diagram 300 of FIG. 6A shows three flush events in which an RST is generated. Further, the TIME SETPOINT of the time-based meter device 120, e.g., the mechanical timer 162 of FIG. 3B, is, for example, set at 240 seconds. At each flush, the time-based meter device 120 measures a flowtime of, for example, about 60 seconds. In this example, for each flush, the flowtime never reaches the TIME SETPOINT (e.g., 240 seconds) before the next RST occurs and therefore no FAULT condition is generated. The example TIME SETPOINT of 240 seconds is used herein as a non-limiting example only. Other values for the TIME SETPOINT are contemplated herein and are within the scope of the presently disclosed technology.

Similarly, the schematic diagram 305 of FIG. 6B shows three flush events in which an RST is generated. Further, the VOLUME SETPOINT of the volume-based meter device 120, e.g., mechanical flow meter 160 of FIG. 3A, is set at, for example, 256 ounces. At each flush, the volume-based meter device 120 measures a flow volume of, for example, about 204 ounces. In this example, for each flush, the flow volume never reaches the VOLUME SETPOINT (e.g., 256 ounces) before the next RST occurs. Therefore, no FAULT condition is generated. The example VOLUME SETPOINT of 256 ounces is used herein as a non-limiting example only. Other values for the VOLUME SETPOINT are contemplated herein and are within the scope of the presently disclosed invention.

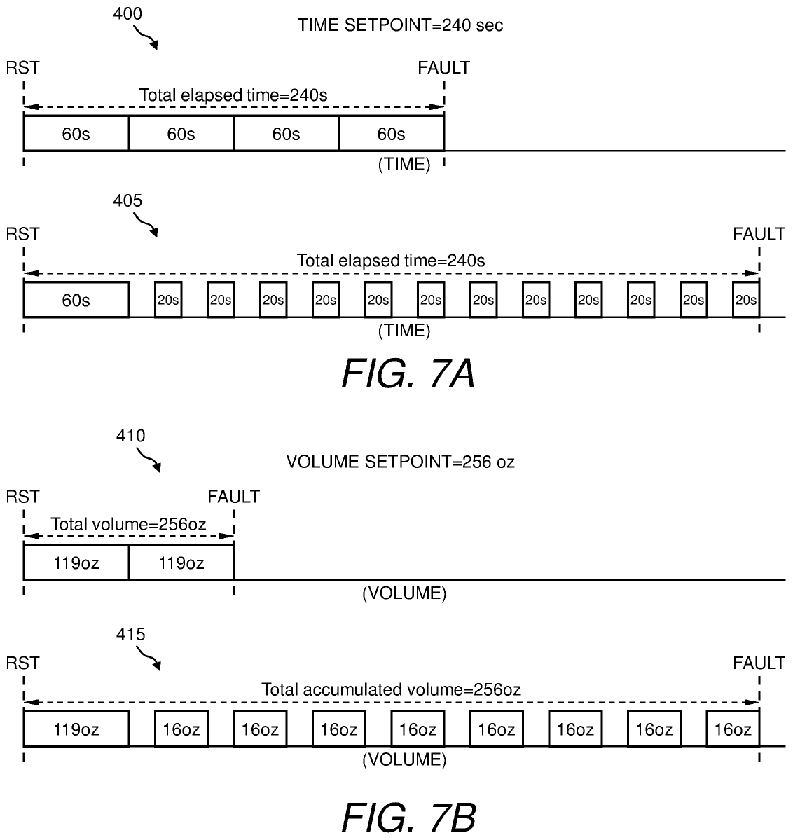

By contrast, FIG. 7A and FIG. 7B are schematic diagrams of the operation of a time-based and a volume-based meter device 120, respectively, in the presence of an excessive flow condition (or FAULT condition). In one example, the schematic diagram 400 of FIG. 7A shows one flush event in which a RST is generated. Further, the TIME SETPOINT of the time-based meter device 120, e.g., the mechanical timer 162 of FIG. 3B, is 240 seconds. At this one flush event there is a malfunction in which a continuous flow occurs, and the total flowtime reaches the TIME SETPOINT of 240 seconds, as measured by the time-based meter device 120, before the next RST occurs. As a result, a FAULT condition is generated and the time-based meter device 120 acts to close the fill valve 122. The conditions illustrated in the schematic diagram 400 may correspond, for example, to a flapper 119 that is stuck open.

In another example, the schematic diagram 405 of FIG. 7A shows one flush event in which an RST is generated. Again, the TIME SETPOINT is 240 seconds. At this one flush event, there is a malfunction in which intermittent flow occurs, and the total elapsed flowtime reaches the TIME SETPOINT of 240 seconds, as measured by the time-based meter device 120, before the next RST occurs. Again, a FAULT condition is generated and the time-based meter device 120 acts to close the fill valve 122. The conditions illustrated in schematic diagram 405 may correspond, for example, to a leaky flapper 119.

Similarly, the schematic diagram 410 of FIG. 7B shows one flush event in which an RST is generated. Further, the VOLUME SETPOINT of the volume-based meter device 120, e.g., the mechanical flow meter 160 of FIG. 3A, is 256 ounces. At this one flush event, there is a malfunction in which a continuous flow occurs, and the total flow volume reaches the VOLUME SETPOINT of 256 ounces, as measured by the volume-based meter device 120, before the next RST occurs. As a result, a FAULT condition is generated and the volume-based meter device 120 acts to close fill valve 122. The conditions illustrated in schematic diagram 410 may correspond, for example, to a flapper 119 that is stuck open.

In another example, the schematic diagram 415 of FIG. 7B shows one flush event in which an RST is generated. Again, the VOLUME SETPOINT is 256 ounces. At this one flush event there is a malfunction in which intermittent flow occurs, causing the total flow volume to reach the VOLUME SETPOINT of 256 ounces, as measured by the volume-based meter device 120, before the next RST occurs. Again, a FAULT condition is generated and the volume-based meter device 120 acts to close fill valve 122. The conditions illustrated in schematic diagram 415 may correspond, for example, to a leaky flapper 119.

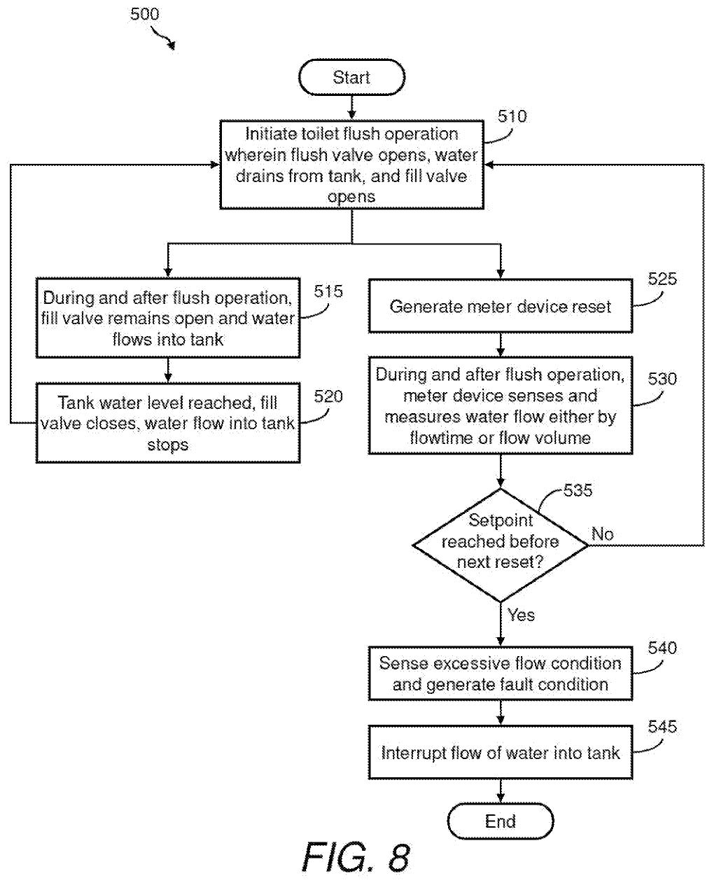

FIG. 8 is a flow diagram of an example of a method 500 of operation of the toilet system 100, including the presently disclosed water flow sensing mechanism, e.g., the time-based and/or volume-based meter device 120, shown and described hereinabove with reference to FIG. 1 through FIG. 7B. The use of the toilet system 100 that includes meter device 120, in accordance with the method 500, can avoid the dumping of excessive amounts of water down the drain, and the associated cost thereof, in the event of a malfunction of the toilet system 100.

The method 500 may include, but is not limited to, the following steps. In the method 500, method steps 510, 515, and 520 may happen concurrently to method steps 510, 525, 530, 535, 540, and 545.

At step 510, a toilet flush operation is initiated wherein the flush valve 118 opens, water drains from the toilet tank, and the fill valve opens. For example and referring now to the toilet system 100 of FIG. 1 and FIG. 2, a toilet flush operation is initiated when a user actuates the flush handle and thereby actuates the flush handle arm 126. As a result, the flapper 119 opens and water drains through the flush valve 118 and into the toilet bowl 116. At the same time, the float 124 drops down and opens the fill valve 122, which begins the flow of water into the toilet tank 110 from the water supply 112. The method 500 then proceeds to both step 515 and step 525.

At step 515, during and after the flush operation is completed, the fill valve 122 remains open and water flows into the toilet tank 110. For example, during and after the flush operation is completed, the fill valve 122 remains open and water flows into toilet tank 110. The method 500 proceeds to step 520.

At step 520, the full water level of the toilet tank 110 is reached, the fill valve 122 closes, and the flow of water into the toilet tank 110 stops. For example, the fill level 152 of the toilet tank 110 is reached, causing the float 124 to rise and thereby close the fill valve 122 and stop the flow of water into toilet tank 110. The method 500 then returns to step 510, and awaits the next flush event.

At step 525, a reset is generated to the time-based or volume-based meter device. For example, when a user actuates the flush handle and thereby actuates the flush handle arm 126, the linkage 136 is used to toggle the arm 121 of the time-based or volume-based meter device 120, thereby generating a reset (RST) condition within meter device 120. For the time-based meter device 120, the reset (RST) condition means that the measured flowtime is reset to zero. For the volume-based meter device 120, the reset (RST) condition means that the measured flow volume is reset to zero. The method 500 then proceeds to step 530.

At step 530, during and after the flush operation, the time-based or volume-based meter device senses and measures the water flow either by flowtime or flow volume. In one embodiment, during and after the flush operation, the time-based meter device 120 shown in FIG. 3B senses and measures the flowtime of the water through fill valve 122. In another embodiment, during and after the flush operation, the volume-based meter device 120 shown in FIG. 3A senses and measures the flow volume of the water through fill valve 122. The method 500 then proceeds to step 535.

At a decision step 535, it is determined whether the setpoint of the time-based or volume-based meter device is reached before the next reset (RST) is generated. In one embodiment, the time-based meter device 120 measures the flowtime and determines whether the TIME SETPOINT is reached before the next reset (RST) is generated. For example, the TIME SETPOINT may be 240 seconds as shown in FIG. 6A and FIG. 7A. In another example, the volume-based meter device 120 measures the flow volume and determines whether the VOLUME SETPOINT is reached before the next reset (RST) is generated. For example, the VOLUME SETPOINT may be 256 ounces as shown in FIG. 6B and FIG. 7B. If the setpoint of the time-based or volume-based meter device is not reached before the next reset (RST) is generated, then method 500 returns to step 510. However, if the setpoint of the time-based or volume-based meter device is reached before the next reset (RST) is generated, then method 500 proceeds to step 540.

At step 540, the excessive flow condition is sensed by the time-based or volume-based meter device, and a fault condition is generated. In one example, the time-based meter device 120 (see FIG. 3B) senses that the flowtime has reached the TIME SETPOINT before the next reset (RST) occurs and generates a FAULT condition, as shown, for example, in FIG. 7A (e.g., TIME SETPOINT=240 seconds). In another example, the volume-based meter device 120 (see FIG. 3A) senses that the flow volume has reached the VOLUME SETPOINT before the next reset (RST) occurs and generates a FAULT condition, as shown, for example, in FIG. 7B (e.g., VOLUME SETPOINT=256 ounces). The method 500 then proceeds to step 545.

At a step 545, the flow of water into the toilet tank 110 is interrupted or stopped using the time-based or volume-based meter device. For example, using the time-based meter device 120 (see FIG. 3B) or volume-based meter device 120 (see FIG. 3A), when the FAULT condition occurs, the linkage 138 between the meter device 120 and the float 124 is used to physically move the float 124 upward to close, i.e., turn off, the fill valve 122. In this way, the flow of water into the toilet tank 110 from the water supply 112 is interrupted or stopped. In this way, dumping an excessive amount of water down the drain, and the associated cost of doing so, are avoided.

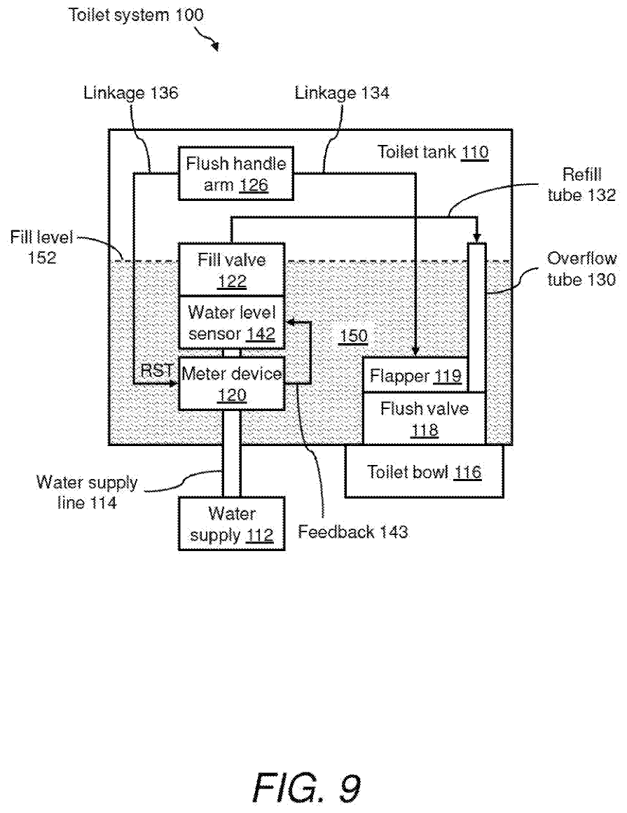

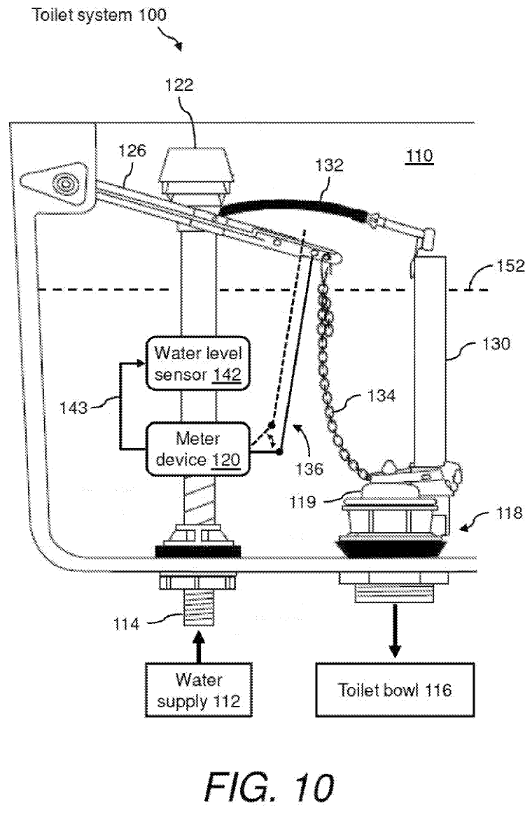

FIG. 9 is a block diagram of an embodiment of the toilet system 100 that includes the meter device 120 fluidly coupled to another type of fill valve 122. This is another example of the presently disclosed water flow sensing mechanism for sensing and stopping an excessive flow condition. FIG. 10 is a front view of the toilet tank 110, showing an example of the physical implementation of toilet system 100 shown in FIG. 9. In this example the fill valve 122 includes a water level sensor 142, instead of the float 124. The water level sensor 142 may be, for example, a head pressure sensor that closes the fill valve 122 when a certain head pressure is reached, and opens the fill valve 122 when below the certain head pressure. In this example, the time-based or volume-based meter device 120 may provide feedback 143 to the water level sensor 142 that indicates whether a FAULT condition is present. In response to the FAULT condition of feedback 143, the water level sensor 142 may be prompted to close, i.e., turn off, the fill valve 122. Again, the reset (RST) may be generated by movement of the flush handle arm 126, or automatically via a timer and the absence of any sensed water flow. The method 500 may be adapted for the toilet system 100 shown in FIG. 9 and FIG. 10.

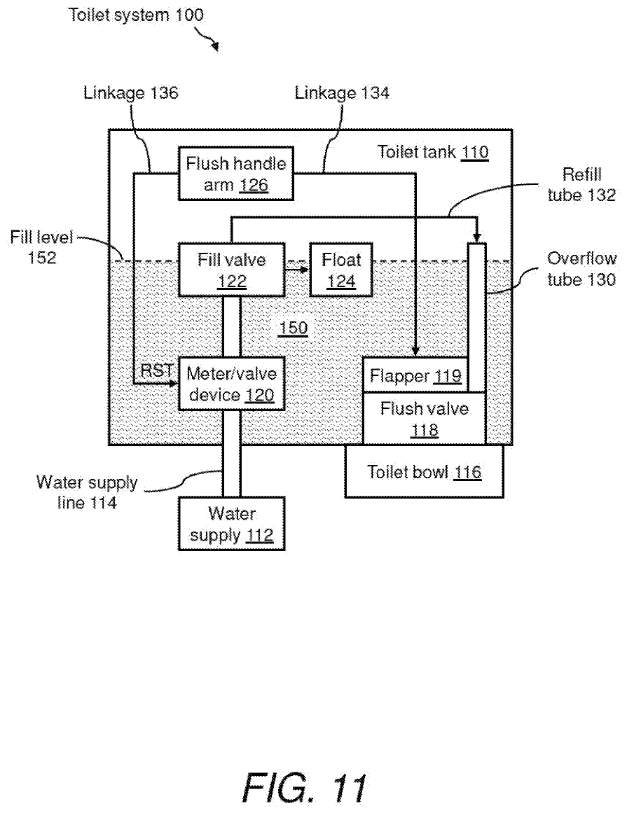

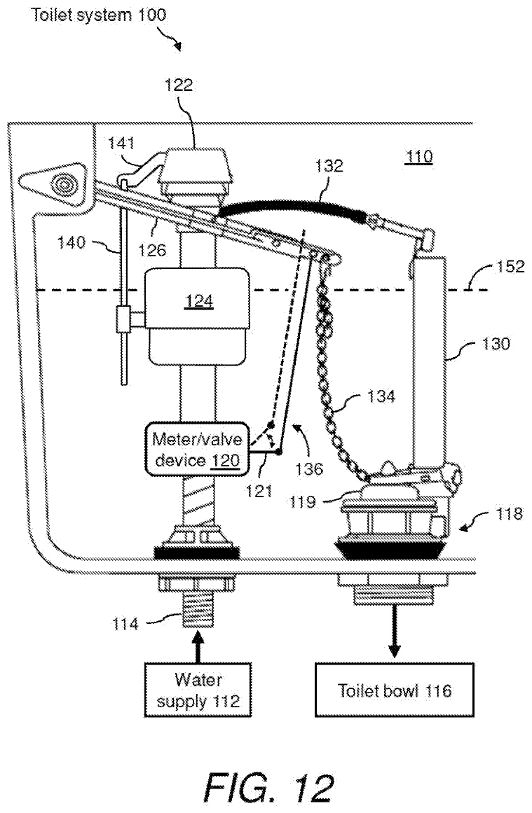

FIG. 11 is a block diagram of the toilet tank 110 including a meter/valve device 120, which is yet another example of the presently disclosed water flow sensing mechanism for sensing and stopping an excessive flow condition. Further, FIG. 12 is a front view of toilet tank 110 and showing an example of the physical implementation of the toilet system 100 shown in FIG. 11. In this example, toilet tank 110 may include a meter/valve device 120. The meter/valve device 120 may include all the meter functions described with reference the meter device 120 of FIG. 1 through FIG. 10.

However, in addition, the meter/valve device 120 may include a built-in valve. Accordingly, there is no need for the meter/valve device 120 to interact directly with the fill valve 122 to stop the flow of water. Rather, the meter/valve device 120 itself may be used to stop the flow of water. Again, the reset (RST) may be generated by movement of the flush handle arm 126, or automatically via a timer and in combination with no flow being sensed. Also, the method 500 may be adapted for the toilet system 100 shown in FIG. 11 and FIG. 12.

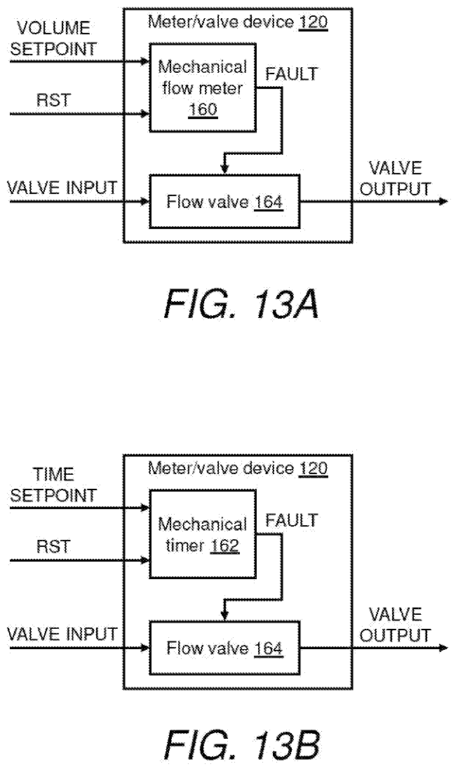

For example, FIG. 13A and FIG. 13B are block diagrams showing two examples of the meter/valve device 120 shown in FIG. 11 and FIG. 12. FIG. 13A shows a volume-based meter/valve device 120 that includes the mechanical flow meter 160 as described in FIG. 3A. The volume-based meter/valve device 120 may further include a flow valve 164. In the toilet system 100, both the mechanical flow meter 160 and the flow valve 164 of the volume-based meter/valve device 120 are in the flow path of the water supply line 114. In this example, the flow valve 164 is a normally-open flow valve 164. When the mechanical flow meter 160 generates a FAULT condition, the flow valve 164 is prompted to close, i.e., turn off. Further, the volume-based meter/valve device 120 operates mechanically, not electrically, and is designed to operate while submerged in water.

Similarly, FIG. 13B shows a time-based meter/valve device 120 that includes a mechanical timer 162 as described in FIG. 3B. The time-based meter/valve device 120 may further include the flow valve 164. In the toilet system 100, both the mechanical timer 162 and the flow valve 164 of the volume-based meter/valve device 120 are in the flow path of the water supply line 114. In this example, the flow valve 164 is a normally open flow valve 164. When the mechanical timer 162 generates a FAULT condition, the flow valve 164 is prompted to close, i.e., turn off. Also, the time-based meter/valve device 120 operates mechanically, not electrically, and is designed to operate while submerged in water.

In both the volume-based meter/valve device 120 and the time-based meter/valve device 120, the flow valve 164 operates independent of the fill valve 122 to control the flow of water into the toilet tank 110.

While FIG. 1 through FIG. 13B describe meter devices 120 and/or meter/valve devices 120 that are installed and operate inside the toilet tank 110, other examples may be installed and operate outside the toilet tank 110.

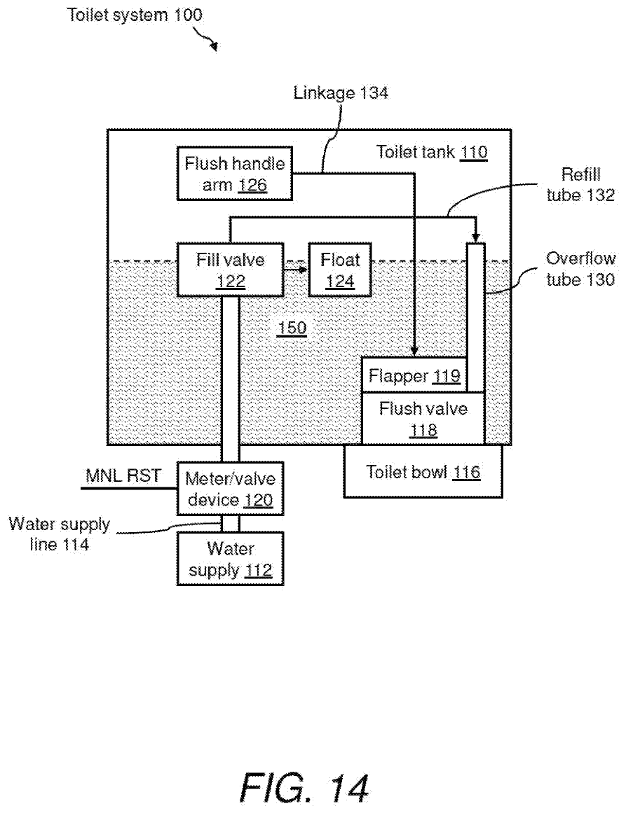

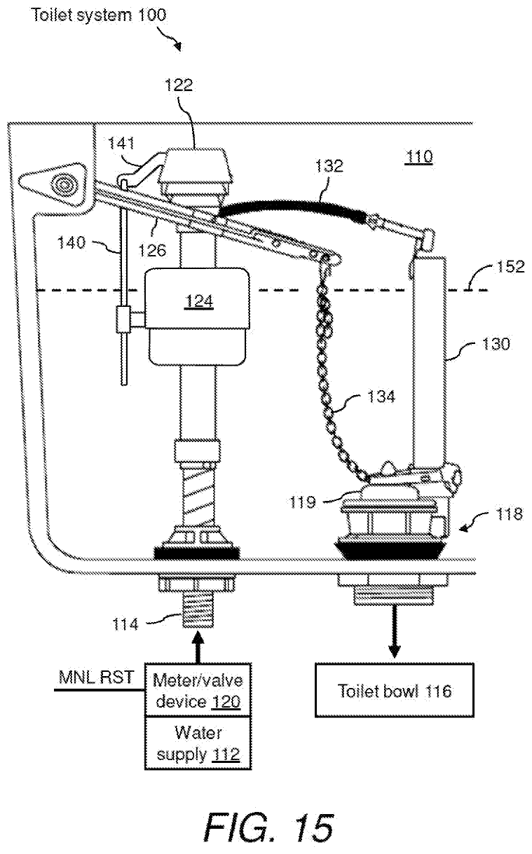

FIG. 14 is a block diagram of the toilet system 100 and showing an example of the meter/valve device 120 located outside the toilet tank 110, which is yet another example of the presently disclosed water flow sensing mechanism for sensing and stopping an excessive flow condition. Further, FIG. 15 is a front view of toilet tank 110 and showing an example of the physical implementation of toilet system 100 shown in FIG. 14. The toilet system 100 shown in FIG. 14 and FIG. 15 is substantially the same as the toilet system 100 shown in FIG. 11 and FIG. 12, with the exception that the meter/valve device 120 is moved outside of the toilet tank 110. Also, while the toilet systems 100 described in FIG. 1 and FIG. 12 provide an automatic reset (RST) to the meter devices 120 and/or the meter/valve devices 120 via movement of flush handle arm 126, the toilet system 100 shown in FIG. 14 and FIG. 15 utilizes a manual reset (MNL RST) to the meter/valve device 120, which is outside the toilet tank 110. That is, once a FAULT condition is triggered and the problem subsequently is corrected, a user must manually reset the meter/valve device 120 via, for example, a button or lever. In another example, instead of the manual reset (MNL RST), the reset (RST) may be generated automatically via a timer, and with no flow being sensed. Also, the method 500 may be adapted for the toilet system 100 shown in FIG. 14 and FIG. 15.

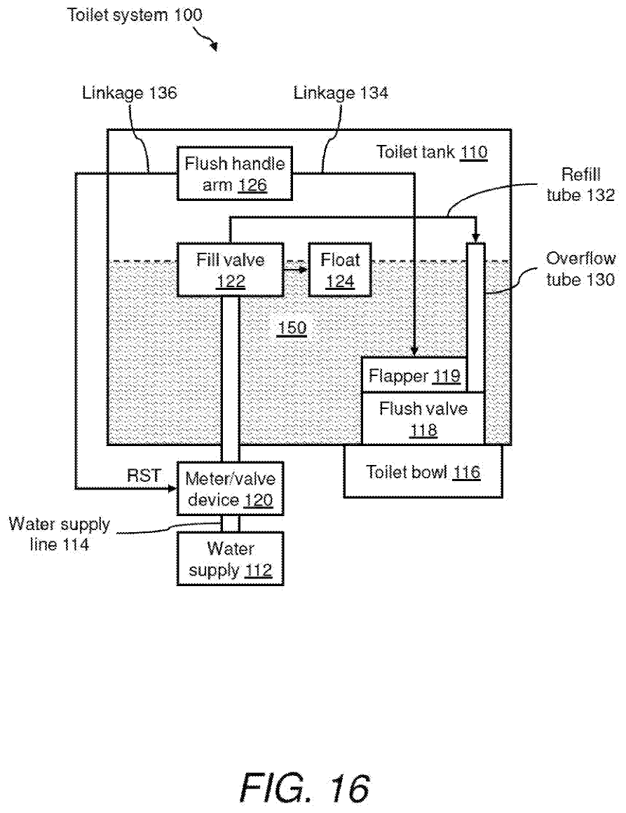

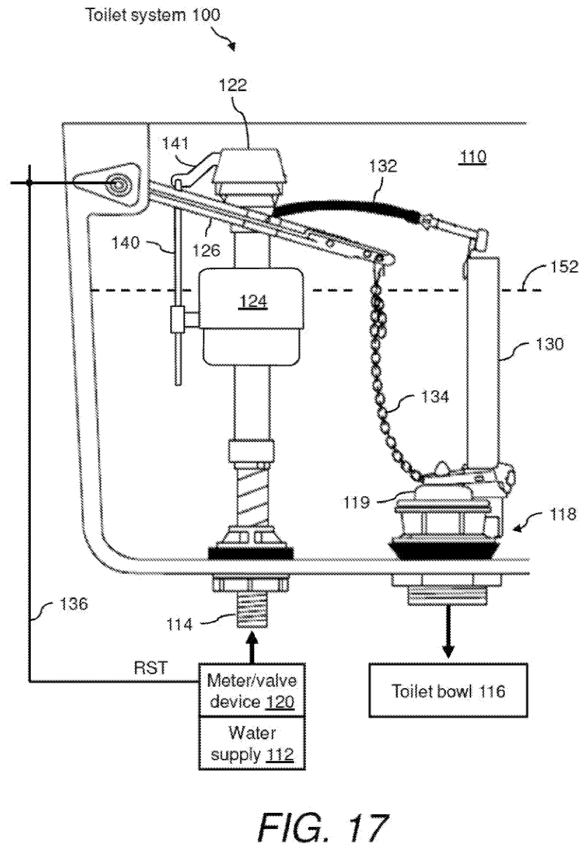

FIG. 16 is a block diagram of the toilet system 100, showing another example of the meter/valve device 120 located outside the tank. This is another example of the presently disclosed water flow sensing mechanism for sensing and stopping an excessive flow condition. FIG. 17 is a front view of the toilet tank 110 and showing an example of the physical implementation of toilet system 100 shown in FIG. 16. The toilet system 100 shown in FIG. 16 is substantially the same as the toilet system 100 shown in FIG. 14 and FIG. 15, with the exception that the meter/valve device 120 has an automatic reset (RST) instead of the manual reset (MNL RST). In this example, the automatic reset (RST) is generated via movement of the flush handle arm 126. However, in this example, the linkage 136 between flush handle arm 126 and meter/valve device 120 must physically exit toilet tank 110 and connect to meter/valve device 120, which is outside the toilet tank 110. Further, the method 500 may be adapted for the toilet system 100 shown in FIG. 16 and FIG. 17.

While the disclosed water flow sensing mechanism for sensing and stopping an excessive flow condition, such as the meter devices 120 and/or meter/valve devices 120 shown in FIG. 1 through FIG. 17, have been described with reference to installation in a toilet, the disclosed water flow sensing mechanisms are not limited to toilets. The disclosed water flow sensing mechanisms may be installed with respect to any appliance that uses water and has the potential for a leak or spill.

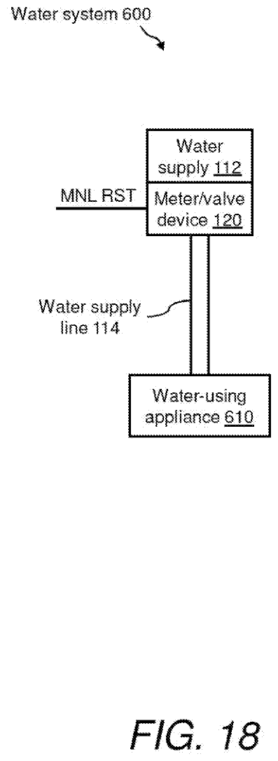

For example, FIG. 18 is a block diagram of a water system 600 including a meter/valve device, which is still another example of the presently disclosed water flow sensing mechanism for sensing and stopping an excessive flow condition. For example, the water system 600 may include any water-using appliance 610 that may be connected to water supply 112 via water supply line 114. The water-using appliance 610 can be, as non-limiting examples, a dishwasher, a clothes washer, a refrigerator, a garden hose, and the like. In the water system 600, the meter/valve device 120 may be installed in the flow path of water supply line 114. In this example, meter/valve device 120 has the manual reset (MNL RST). For example, in the case that water supply line 114 is a washing machine hose, if the hose fails and begins to leak, then meter/valve device 120 provides a safety-stop or flood-stop mechanism to stop the flow. Further, the method 500 may be adapted for water system 600 shown in FIG. 18.

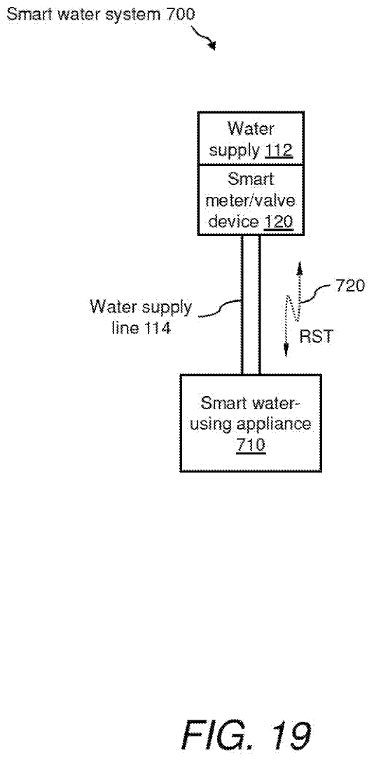

FIG. 19 is a block diagram of a “smart” water system 700 including a “smart” meter/valve, which is still another example of the presently disclosed water flow sensing mechanism for sensing and stopping an excessive flow condition. For example, the smart water system 700 may include any smart water-using appliance 710 that may be connected to the water supply 112 via water the supply line 114. The smart water-using appliance 710 may be, as a non-limiting example, a smart dishwasher, a smart clothes washer, a smart refrigerator, and the like.

In the smart water system 700, a smart meter/valve device 120 may be installed in the flow path of the water supply line 114. In this example, a wireless communications link 720 may exist between the smart water-using appliance 710 and the smart meter/valve device 120. The wireless communications link 720 may be any short-range wireless communications technology, such as, but not limited to, ultra-wideband (UWB), Wi-Fi, ZigBee, Bluetooth®, infrared (IR), and the like. In one example, the reset (RST) signal may be exchanged wirelessly. Further, the method 500 may be adapted for the smart water system 700 shown in FIG. 19.

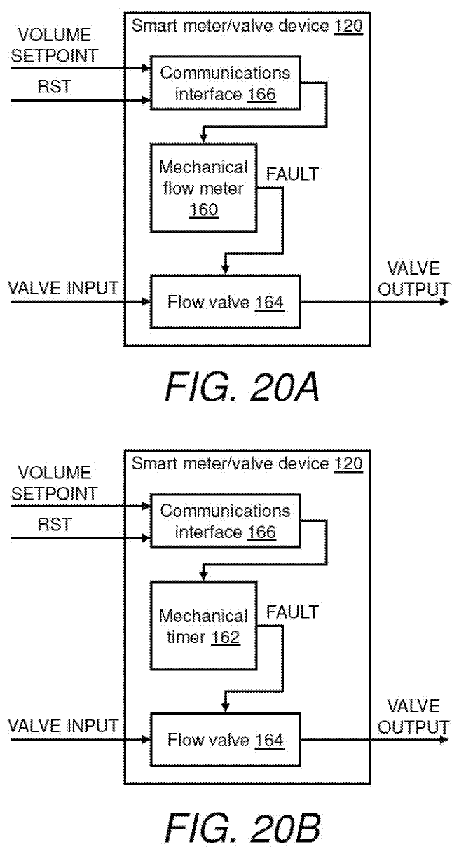

FIG. 20A and FIG. 20B are block diagrams showing two examples of the smart meter/valve devices 120 shown in FIG. 19. FIG. 20A shows a smart volume-based meter/valve device 120 that includes the mechanical flow meter 160 and the mechanical flow valve 164 as described in FIG. 13A. FIG. 20B shows a smart time-based meter/valve device 120 that includes the mechanical timer 162 and the mechanical flow valve 164 as described in FIG. 13B. Further, both smart volume-based meter/valve devices 120 may include a communications interface 166. The communications interface 166 may be based on any short-range wireless communications technology, such as, but not limited to, UWB, Wi-Fi, ZigBee, Bluetooth®, IR, and the like.

Generally, in FIG. 1 through FIG. 20B, in any instances of meter devices 120 and/or meter/valve devices 120, the reset (RST) may be generated manually and/or automatically. Further, in FIG. 1 through FIG. 20B, any instances of the fill valve 122 may be “smart” fill valves that may include, for example, wireless communications capability.

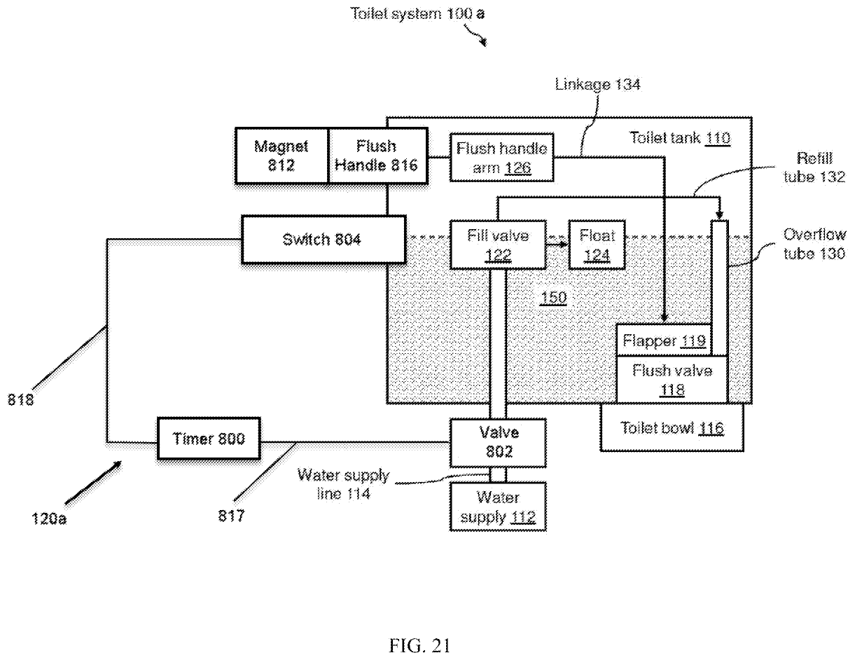

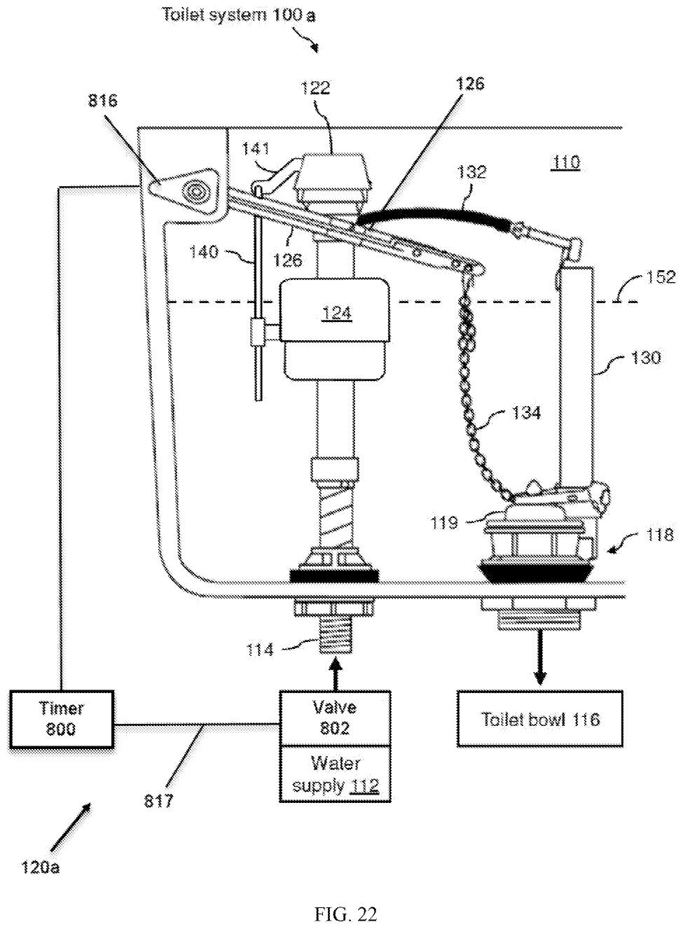

FIGS. 21 and 22 depict an alternative embodiment of the toilet system 100 in the form of a toilet system 100a. Except where otherwise noted below, the toilet system 100a is substantially identical to the toilet system 100, and the above description of the toilet system 100 applies equally to the toilet system 100a. Components of the toilet system 100a that are substantially identical to components of the toilet system 100 are denoted using identical reference characters.

The toilet system 100a includes a timer-based meter device 120a. The meter device 120a comprises a timer 800, a fault device in the form of a fault valve or valve 802, and a switch 804. The timer 800 and the valve 802 are described herein as separate components. The timer 800 and the valve 802 can be configured as a single, integral unit in alternative embodiments of the meter device 120a.

The switch 804 is communicatively coupled to the timer 800, and provides the timer 800 with an indication of the commencement of a flush event, i.e., the switch 804 resisters when the toilet system 100a is flushed.

The valve 802 is in fluid communication with the water supply 112, and is located upstream of the toilet tank 110 and the fill valve 122 of the toilet system 100. The valve 802 is configured operate in an open state and a closed state. When in the closed state, the valve 802 prevents the flow of water to the fill valve 122 from the water supply 112. When in the open state, the valve 802 permits water to flow to the fill valve 122 from the water supply 112.

The valve 802 is located outside of the toilet tank 110. The valve 802 can be located inside the toilet tank 110 in alternative embodiments of the device 120. The valve 802 is communicatively coupled to the timer 800 by wire leads 817. The valve 802 can be communicatively coupled to the timer 800 by a suitable wireless means in alternative embodiments. The valve 802 is electrically actuated, and is energized by the timer 800. Alternative embodiments of the valve 802 can be powered by their own dedicated power source.

The valve 802 can be any type of valve suitable for selectively interrupting the flow of water therethrough. For example, the valve 802 can be a gate valve, a ball valve, a butterfly valve, etc. The valve 802 can be biased by a spring or other suitable means to remain in its closed state when not energized, i.e., energization of the valve 802 by the timer 800 causes the valve 802 to open, and de-energization of the valve 802 causes the valve 802 to close.

The timer 800 is located outside of the toilet tank 110. The timer 800 can be located inside the toilet tank 110 in alternative embodiments of the device 120. The timer 800 can be powered by one or more batteries. Alternative embodiments of the timer 800 can be powered by other suitable means, such as standard household 120-volt or 240-volt AC power, solar cells, etc.

The timer 800 can be, for example, a programmable digital timer configured to generate an electrical output after a predetermined amount of time has elapsed. Other types of timers, including electrical and mechanical timers, can be used in the alternative. The timer 800 is communicatively coupled to the switch 804 by a suitable means such as wire leads 818. The wire leads 818 can extend through a sealed opening in the toilet tank 110. Alternatively, the leads 818 can be routed out of the top of the toilet tank 110, between the toilet tank 110 and the tank lid. The timer 800 can be communicatively coupled to the switch 804 by a suitable wireless means in alternative embodiments.

The switch 804, as noted above, is configured to provide an indication of the start of each flush event. The timer 800, upon receiving the indication of the flush event, commences a timed count of predetermined duration. The predetermined duration can be a set point programmed by the user. Alternatively, the set point can be fixed, i.e., not subject to adjustment by the user. As discussed above in relation to the time-based meter device 120, the duration of the count, i.e., the setpoint, can be chosen to provide sufficient time for the toilet tank 110 to fill under normal conditions, i.e., without a malfunction or mis-adjustment that results in leakage from the toilet tank 110.

Upon receiving an indication of a flush event from the switch 804, the timer 800 also generates an output that is received by the valve 802. More specifically, and as a non-limiting example, the timer 800 can comprise a relay (not shown) that closes upon the start of the timed count. The relay, upon closing, causes the timer 800 to generate an electrical output that, when received by the valve 802, energizes the valve 802, causing the valve 802 to open, i.e., causing the valve 802 to change from its closed state to its open state. Thus, in response to the flush event, fill water can flow from the water supply 112, through the valve 802, and to the fill valve 122 of the toilet system 100. Alternative embodiments of the meter device 120a can include a mechanical linkage coupled to the timer 800 and the valve 802 for providing a mechanical input from the timer 800 to the valve 802, to cause the valve 802 to move between the open and closed states.

Absent any leakage of water from the toilet tank 110, the float 124, which rises in response to the rising water level in the toilet tank 110, eventually reaches a height at which the float 124 closes the fill valve 122, interrupting the flow of water to the toilet tank 110. As noted above, the duration of the timed count maintained by the timer 800, i.e., the timer setpoint, is selected to be long enough to permit a sufficient volume of water to flow into the toilet tank 110 to raise the water to its normal fill level 152, absent a malfunction or mis-adjustment that results in leakage from the toilet tank 110. Once the timed count reaches the set point, the internal relay within the timer 800 opens, de-energizing the valve 802 and causing the valve 802 to return to its closed state. In addition, the timer 800 resets the timed count, i.e., the elapsed time, to zero; and the count will remain at zero until the start of the next flush event, i.e., until the switch 804 generates an indication that the next flush event has commenced. In the event the user initiates another flush event before the timed count reaches the set point, the timer 800, upon receiving the indication of the flush event from the switch 804, will reset the timed count to zero.

Under normal circumstances, i.e., absent any water leakage from the toilet tank 110, the flow of water to the toilet tank 110 is interrupted by the closing of the fill valve 122 by the float 124, followed by the return of the valve 802 to its closed state.

If a relatively large volume of water is leaking from the toilet tank 110, such as when the flapper 119 remains in the open position or the “full” setpoint for the fill valve 122 is set too high, the fill water likely will be flowing when the timed count maintained by the timer 800 reaches the setpoint. Under this circumstance, the closing of the valve 802 when the timed count reaches its setpoint will interrupt the flow of fill water to the fill valve 112. And because the valve 802 will remain closed until the next flush event, the valve 802 will prevent the leakage of water, and the corresponding cost, that otherwise would have resulted from the malfunctioning or improperly adjusted toilet system 100.

Similarly, if a relatively small volume of water is leaking from the toilet tank 110, and/or if the leak is intermittent, such as may occur with a leaky flapper 119, the valve 802, upon closing, will prevent the leakage of water that otherwise would have resulted from the malfunction. And because the valve 802 defaults to its closed position whenever the timer 800 is not maintaining the timed count, the meter device 120a is equally effective at reducing small-volume leaks, large-volume leaks, continuous leaks, and intermittent leaks. Also, the valve 802 will perform this protective function when the batteries of the timer 800 are low or completely depleted, or when the meter device 102a otherwise does not have a source of electric power.

The switch 804 can be, for example, a reed switch that operates in conjunction with a magnet 812 to provide the timer 800 with an indication that a flush handle 816 of the toilet system 100, and the attached flush handle arm 126, have been rotated to actuate the flush valve 118 and thereby initiate a flush event. The use of a reed switch as the switch 804 is disclosed for illustrative purposes only. Other means for indicating the start of a flush event, including but not limited to other types of electrical and mechanical switches, optical sensors, motion sensors, force sensors, a mechanical linkage between the flush handle 816 and the timer 800, etc., can be used in alternative embodiments. In other alternative embodiments, the start of a flush event can be determined based on an event other than rotation of flush handle 816. For example, movement of the flush handle arm 126, the flush valve 118, or other components of the toilet system 100 can be detected and used by the timer 800 as an indication of the start of a flush event.

The magnet 812 is secured to the flush handle 816, by a suitable means such as adhesive. The switch 804 is secured to an interior surface of the toilet tank 110, by a suitable means such as adhesive. The switch 804 and the magnet 812 are positioned so that the switch 804 is located within the magnetic field generated by the magnet 812, when the flush handle 816 is in the released position, i.e., when the flush handle 816 is not being rotated or otherwise deflected by the user to initiate a flush event. Also, the switch 804 and the magnet 812 are positioned so that the switch 804 is located substantially outside of the magnetic field of the magnet 812 when the flush handle 816 is fully rotated or otherwise deflected by the user to initiate a flush event.

The switch 804 has two internal contacts (not shown). Each contact is electrically connected to a respective one of the wire leads 818. The contacts are configured so that the contacts are in an open state, i.e., the contacts do not contact each other, when the switch 804 is located within the magnetic field of the magnet 812. More specifically, the magnetic field causes the contacts to deflect away from each other, and to remain out of contact.

The rotation of the flush handle 816 as the user commences a flush event causes the magnet 812 to move away from the switch 804. This movement diminishes or eliminates the magnetic field acting on the contacts of the reed switch 804, allowing the contacts to defect into contact with each other and establishing the closed state of the switch 804. The closed contacts, the wire leads 818, and the timer 800 from an energized electric circuit. The timer 800, upon detecting the energized circuit, commences the elapsed time count, and energizes the valve 802 as discussed above.

When the flush handle 816 returns to its released position after being released by the user, the switch 804 once again is located within the magnetic field of the magnet 812, causing the contacts of the switch 804 to separate and returning the switch 804 to its open state. The switch 804 at this point is ready to indicate the start of the next flush event.

The meter device 120a, meter devices 120, and meter/valve devices 120 can be adapted for use with water-using appliances other than toilets. For example, the timer 800, and variants thereof, can be installed in the water supply of a washing machine or an automatic dishwasher. A variant of the switch 804 can be installed on the washing machine or dishwasher to provide the timer 800 with an indication of the start of a wash cycle. As discussed above in relation to the toilet system 100a, the timer 800 and the valve 804 can operate in conjunction to interrupt the flow of water to the washing machine or the dishwasher after a predetermined amount of time has elapsed following commencement of the wash cycle.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

The term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

What is claimed is:

1. A meter device configured for use with a toilet system and a water supply, the toilet system comprising a toilet tank; a flush valve; a toilet bowl fluidly coupled to the toilet tank upon actuation of the flush valve; and a fill valve configured to be fluidly coupled to the water supply via the meter device, and to supply water to the toilet tank to maintain a water level in the tank at a fill level; the meter device comprising:
a fault valve configured to be fluidly coupled to the water supply and the fill valve of the toilet, and further configured to, during operation, interrupt a flow of water from the water supply to the fill valve on a selective basis; and
a timer operably coupled to the fault valve and configured to, during operation, (i) determine an elapsed time after actuation of the flush valve; and (ii) cause the fault valve to prevent the flow of water from the water supply to the fill valve when the elapsed time reaches a setpoint.

2. The meter device of claim 1, wherein the timer is a programmable digital timer communicatively coupled to the fault valve.

3. The meter device of claim 1, wherein:
the fault valve is further configured to operate in an open state in which the fault valve permits the flow of water from the water supply to the fill valve, and a closed state in which the fault valve prevents the flow of water from the water supply to the fill valve.

4. The meter device of claim 3, wherein:
the timer is further configured to energize the fault valve when the flush valve is actuated; and
the fault valve is further configured to change from the closed state to the open state upon being energized.

5. The meter device of claim 4, wherein:
the timer is further configured to de-energize the fault valve when the elapsed time after actuation of the flush valve reaches the setpoint; and
the fault valve is further configured to change from the open state to the closed state upon being de-energized.

6. The meter device of claim 3, wherein:
the timer is further configured to generate a first output when the flush valve is actuated; and
the fault valve is further configured to change from the closed state to the open state upon receiving the first output.

7. The meter device of claim 6, wherein:
the timer is further configured to generate a second output when the elapsed time reaches the setpoint; and
the fault valve is further configured to change from the open state to the closed state upon receiving the second output.

8. The meter device of claim 1, wherein the timer is further configured to reset the elapsed time to zero when the elapsed time reaches the setpoint.

9. The meter device of claim 1, wherein the setpoint is an amount of time longer than an amount of time needed for the water level in the toilet tank to reach the fill level after actuation of the flush valve.

10. The meter device of claim 3, further comprising a switch operably coupled to the timer and configured to generate an output when the flush valve is actuated.

11. The meter device of claim 10, wherein the timer is further configured to: (i) begin determining the elapsed time after actuation of the flush valve upon receiving the output of the switch, and (ii) cause the fault valve to change from the closed state to the open state upon receiving the output of the switch.

12. The meter device of claim 10, wherein the switch is a reed switch communicatively coupled to the timer.

13. The meter device of claim 12, further comprising a magnet, wherein:
the magnet is in a first position in relation to the reed switch as the flush valve is actuated;
the magnet is in a second position in relation to the reed switch when the flush valve is not actuated;
the reed switch is configured to close when the magnet is in the first position in relation to the reed switch; and
the reed switch is configured to generate the output of the reed switch when the reed switch is closed.

14. A meter device configured for use with a toilet system and a water supply, the toilet system comprising a toilet tank; a flush valve; a toilet bowl fluidly coupled to the toilet tank upon actuation of the flush valve; and a fill valve configured to be fluidly coupled to the water supply via the meter valve, and to supply water to the toilet tank to maintain a water level in the tank at a fill level; the meter device comprising:
a flow valve configured to be fluidly coupled to the fill valve of the toilet, wherein the flow valve is further configured to, during operation, interrupt a flow of water to the fill valve when the flow valve is actuated; and
a flow meter mechanically or electrically coupled to the flow valve and configured to be fluidly coupled to the flow valve and the water supply, wherein the flow meter is configured to, during operation, (i) determine a cumulative volume of water that flows from the water supply to the fill valve after the flow meter has been reset, and (ii) actuate the flow valve when the cumulative volume of water exceeds a setpoint for the cumulative volume of water.

15. The meter device of claim 14, wherein the fault device is a linkage.

16. The meter device of claim 15, wherein:
the flow meter comprises an impeller configured to rotate in response to passage of the water over the impeller; and
the linkage comprises a gear mounted on the impeller for rotation with the impeller, and a geared rod mechanically coupled to the fill valve, the geared rod being configured to engage the gear so that the geared rod translates linearly toward the fill valve in response to rotation of the gear.

17. The meter device of claim 14, further comprising a reset mechanism configured to reset the flow meter.

18. The meter device of claim 17, where the reset mechanism comprises a reset linkage mechanically coupled to the flow meter, wherein:
the reset linkage is configured to be mechanically coupled to the flush handle of the toilet so that the reset linkage is actuated by movement of the flush handle; and
the flow meter is further configured so that actuation of the reset linkage resets the flow meter.

19. The meter device of claim 14, wherein the volume setpoint is a volume of water greater than the fill volume of the toilet tank.

20. The meter device of claim 14, wherein the fault device is configured to be coupled to a float of the fill valve of the toilet, and to interrupt a flow of water through the fill valve by raising the float.
